(19) United States
(12) Patent Application Publication
(10) Pub. No.: US 2012/0309105 A1
(43) Pub. Date: Dec. 6, 2012

(54) Radioiodine-Labeled Thyroxine Dosimetry, and Methods of Use Thereof

(75) Inventor: Offie P. Soldin, Bethesda, MD (US)

(73) Assignee: GEORGETOWN UNIVERSITY, WASHINGTON, DC (US)

(21) Appl. No.: 13/577,822

(22) PCT Filed: Feb. 7, 2011
(86) PCT No.: PCT/US11/23896

§ 371 Date: Aug. 24, 2012

Related U.S. Application Data
(60) Provisional application No. 61/303,029, filed on Feb. 10, 2010.

(51) Int. Cl. G01N 27/62

(52) U.S. Cl. 436/500

(57) ABSTRACT

Provided are methods of detecting the presence or amount of organified radioiodine, such as radioactive thyroxine, in a sample using mass spectrometry. For example, one aspect of the invention relates to a rapid and sensitive liquid chromatography/tandem mass spectrometry (LC/MS/MS) method for the simultaneous measurement of radioactive thyroxine and non-radioactive thyroxine in human serum/plasma.

### BACKGROUND

Thyroid hormones, such as thyroxine (T4) and triiodothyronine (T3), are critical for homeostasis, growth and differentiation, and act on gene transcription to regulate the basal metabolic rate. Iodine is essential for the synthesis of T4 and T3. T4 and T3 contain four and three iodine atoms per molecule, respectively, and are synthesized solely in the thyroid gland, which actively absorbs iodide from circulation. Thyroxine (T4) is the main metabolic precursor of T3, the more biologically active hormone. Dietary intake is the sole source of iodine for thyroid hormone synthesis.

Of the 37 isotopes of iodine, only ¹²⁷I is stable (Audi G, Wapstra A H, Thibault C, Blachot J, Bersillon, O. Isotope masses from AME 2003 Atomic Mass Evaluation. Nuclear Physics 2003, A729). ¹³¹I is radioactive, emitting beta and gamma radiation, and has a half life of over 8 days. The most common radioactive products from 235-Uranium fission include isotopes of Iodine, Cesium, Strontium, Xenon and Barium. Many of the fission products decay through very short-lived isotopes to form stable isotopes, but also a considerable number of the radioisotopes have half lives longer than a day. In the event of detonation of a nuclear weapon, ¹³¹I is forced upward by intense heat, and is then carried by the wind and deposited on the ground via precipitation. The isotopic signature of the radioactivity released from a power reactor or used fuel is very different from an open air nuclear detonation, where all the fission products are dispersed. Some fission products are useful as beta and gamma sources in medicine and industry.

The release of ¹³¹I into the environment from molten fuel rods is accompanied by a large amount of ¹²⁹I (t½=16 million years). According to a Public Health Assessment, ¹²⁹I, when absorbed into the thyroid, has a half life in the body for up to 120 days. ¹²⁹I is another common isotope of Iodine that has implications for radio exposure. ¹²⁹I is found in large amounts in the environment near nuclear fission in nuclear reactors and since 1945 has been abundant in areas which have seen nuclear activity (Hou X. A Review on speciation of Iodine-129 in the Environment and Biological Samples. Anal Chim Acta, 2009; 632:181-196). ¹²⁹I has a half-life of 16 million years and, therefore, is a more stable isotope than

### ¹³¹I and Childhood Cancer

Prior to the Chernobyl nuclear power plant accident in April 1986 the carcinogenic effect of exposure to ¹³¹I was considered to be small compared with that of external photon exposure (United Nations Scientific Committee on the Effects of Atomic Radiation (UNSEAR) Sources and effects of ionizing radiation, NY, United Nations 1994; Shore R E. Issues in epidemiological evidence regarding radiation induced thyroid cancer. Radiat Res 1992; 131:98-111). Numerous studies have examined the increase in the incidence of thyroid cancer following the emission of ¹³¹I radiation (Cardis E, Kesminiene A, Ivanov V, Malakhova I, Shibata Y, Khrouch V, et al. Risk of Thyroid Cancer After Exposure to 131-I in Childhood. J Natl Cancer Inst. 2005; 97(10):724-32). There is an increased incidence of thyroid cancer in communities near radioactive events (Jang M, Kim H K, Choi C W, Kang C S. Age Dependant Potassium Iodide Effect on the Thyroid Irradiation by 131-I and 133-I in the Nuclear Emergency. Rad Protect Dosim, 2008; 130:499-502).

Most of the studies on the risk of cancer associated with exposure to ¹³¹I had been conducted in adult populations with underlying thyroid disease. A large increase in the incidence of childhood thyroid cancer was reported in contaminated areas following the Chernobyl accident. (Cardis E, Kesminiene A, Ivanov V, Malakhova I, Shibata Y, Khrouch V, et al. Risk of Thyroid Cancer After Exposure to 131-I in Childhood. J Natl Cancer Inst. 2005; 97(10):724-32).

### Thyroidal Uptake of Radioactive Iodine

The thyroidal uptake of radioactive iodine in persons without thyroid disease varies with geographic location, mostly depending on dietary intake, iodine sufficiency, age, sex, and health status (Dyrbe M, Peitersen E, Friis T. Diagnostic Value of I-131 in Thyroidal Disorders. Acta-Medica Scand, 1964; 176:91; Goldberg U L, Richards R, McFarlane H. Thyroidal Uptake of Radioiodine in Normal Subjects in Jamaica. J Clin Endocrinol, 1964; 24:1178; Hoffmann R G, Williams C M, Computer Generation of Normal Values for Thyroid 131-I uptakes. Amer J Roentgen, 1966; 96:727; Maglione, A A, Collica, C J, Rubenfield, S. Advantage of Three Combined Diagnostic Procedures with I-131 for the Evaluation of Thyroid Disorders. Amer J Roentgen, 1966; 97:896; Nelson J, Renschler A, Doswell J. The Normal Thyroidal Uptake of Iodine. California Medicine. Western Journal of Medicine, 1970; 112:11-14; Oddie, T H, Pirnique F G, Fisher D A. Geographic Variation of Radioiodine Uptake in Euthyroid subjects. J Clin Endo, 1968: 28:761).

Radioactive iodine has therapeutic value in ablation therapy following total thyroidectomy in thyroid cancer patients in an attempt to completely eradicate any remaining thyroid cancer cells. This is due to selective uptake of the ¹³¹I by thyroid (cancer) cells. The administration of ¹³¹I in the early postoperative period is termed ¹³¹I remnant ablation (RRA). The need for RRA is greater when large remnants are present or in patients who are at a high risk for recurrence, based on histology, age, or extrathyroidal extension. The goals of RRA are to destroy any microscopic deposits of thyroid carcinoma and to destroy any remaining normal thyroid tissue. Ingested iodine is absorbed through the small intestine and transported in the plasma to the thyroid, where it is concentrated, oxidized, and then incorporated into thyroglobulin (Tg) to form thyroxine, triiodothyronine and their metabolites.

In theory, if one could eliminate all normal thyroid cells, the only remaining source of ¹³¹I-thyroxine (and Tg production) would be malignant thyroid cells. This would then make serum ¹³¹I-thyroxine a more specific tumor marker than Tg due to higher method specificity and sensitivity. Second, if all normal thyroid tissue is destroyed, any subsequent retention of ¹³¹I in the neck region would be the result of residual thyroid cancer. Finally, if microscopic deposits of differentiated thyroid cancer are destroyed, one should expect lower recurrence rates and possibly improved overall survival. A recent study has shown that successful ablation of thyroid cancer is strongly dependant upon the dose of ¹³¹I absorbed by any remaining thyroid cancer cells (Flux G., Haq M, Chittenden S, Buckley S, Hindorf C, Newbold K, Harmer C. A Dose-effect Correlation for Radioiodine Ablation in Differentiated Thyroid Cancer. Eur J Nuc Med Mol Imaging, 2010 February; 37(2):270-5).

Determination of serum Tg is a key element in the follow-up of patients treated for differentiated thyroid carcinoma (DTC). The sensitivity and the specificity of the assay strongly affect the clinical impact. Most of patients are disease-free after thyroidectomy and iodine radioablation; 15% of them show persistent or recurrent disease; of these, 5% die due to worsening of disease. This implies that the follow-up procedures should have a high negative predictive value to reduce unnecessary diagnostic testing and a high positive predictive value to identify the few patients with persistent/recurrent disease. The international guidelines are based on Tg measurement after recombinant human thyroid stimulating hormone (rhTSH) stimulation; follow-up based on serial measurements of basal (i.e. unstimulated) Tg may have a higher predictive value.

Currently, the lack of rise in serum Tg in response to TSH elevation is a more reliable test than whole body scans, with a higher negative predictive value for residual or recurrent cancer, and is used as a criterion for ablation. Tg measurements are not reliable in patients with small lymph node metastases, approximately 20% of patients harbor anti-thyroglobulin antibodies (TgAb) which preclude the accurate use of Tg as a biomarker, and in 15%-20% of patients serum Tg is detectable only after rhTSH stimulation. Therefore, the significance of low detectable Tg levels remains debatable. Yearly follow-up for such patients can consist of a clinical examination with TSH and Tg determinations.

It follows that a more reliable indicator than Tg is needed. In addition, the use of dosimetry-based personalized treatment can be used to prevent sub-optimal administration, which could entail further radioiodine treatment, and excessive administration leading to potential radiation toxicity (Flux G., Haq M, Chittenden S, Buckley S, Hindorf C, Newbold K, Harmer C. A Dose-effect Correlation for Radioiodine Ablation in Differentiated Thyroid Cancer. Eur J Nuc Med Mol Imaging, 2010 February; 37(2):270-5).

### Available Quantitative Dosimetry

Multiple potential drawbacks of current dosimetry may preclude its use in many centers. One problem is the uncertainty of volume determinations by neck ultrasound shortly after thyroid surgery, since the differentiation between scar tissue, hematoma and thyroid remnant is often difficult. The same holds true for the use of computed tomography (CT), magnetic resonance imaging (MRI) and positron emission tomography (PET) to evaluate distant metastatic lesions, especially diffuse lung metastases. Also, it is difficult to predict ¹³¹I kinetics during therapy from prior diagnostic studies owing to the large difference in administered and measured activity and potential subsequent biological effects. However, this wide variation certainly implies that the assessment of meaningful dose-effect relationships and clinical dosimetry should include further development of a quantitative approach.

Approaches in which quantitative dosimetry is performed to estimate the activity dose needed to deliver an effective radiation dose are scarce in the literature. In cases of distant metastases, higher amounts of ¹³¹I are given in single doses and subsequent cumulative therapies. The measurements can be camera-based without blood sampling. More recently, a blood dose formula derivation has provided a new tool for patient-specific blood dose assessment representing marrow dosimetry in DTC therapy. However, for more precise dosimetry, e.g. in dosimetric studies or for higher targeted blood absorbed doses, sequential blood sampling is recommended. The calculated radiation dose serves as a surrogate parameter for the organ at risk, the bone marrow, since to date direct determination of the bone marrow absorbed dose is not feasible.

Treatment with Radioactive Iodine

In non-cancer patients, small doses of ¹³¹I (5-30 millicuries, mCi) are normally given to ablate overactive thyroid tissue. This may turn an overactive thyroid gland into an underactive thyroid gland. Doses of ¹³¹I in the middle range (25-75 mCi) may be used to shrink large thyroid glands that are functioning normally but are causing problems because of their size. Patients can go home after ¹³¹I treatment, although they are asked to follow some precautions (FIG. 1). ¹³¹I treatment may take up to several months to have its full effect.

In the case of thyroid cancer, larger doses of ¹³¹I (30-200 mCi) are needed to destroy remnant thyroid cancer cells. The recommendation to treat with radioactive iodine depends on the extent of surgery, size, number (single vs multifocal) and type of tumor, pathology report, and individual circumstances. In some retrospective analyses, older patients with larger tumors appeared to enjoy a survival benefit from radioactive iodine therapy (Podnos Y D, Smith D D, Wagman L D, Ellenhorn J D. Survival in patients with papillary thyroid cancer is not affected by the use of radioactive isotope. J Surg Oncol 2007; 96:3-7). Because the patient is exposed to a higher dose, he or she needs to remain isolated for a period of time to avoid exposing other people to radiation, especially if there are small children living in the same home. The regulations that determine whether a patient needs to be isolated or can go home after the treatment vary from one state to another.

Monitoring of patients prior to discharge is conducted to ensure that patients are not overtly radioactive at a reasonable distance, for example, several feet away. They are required to avoid sharing food and utensils for several days after the radioactive treatment. Similarly, intimate contact involving exchange of body fluids must be avoided to minimize inadvertent exposure to small amounts of radioactive iodine that may be still present.

Following radiation treatment, patients are generally followed up approximately four to eight weeks after being discharged from the hospital, at which time the blood levels for thyroid hormones, TSH, and thyroglobulin are drawn to make sure patients are on an appropriate dose of L-thyroxine to maintain TSH in the suppressed range.

In some centers, a total body scan is performed, from several days to 2 weeks following ¹³¹I administration. In over 98% of cases, nothing alarming is seen on this scan, and some studies have even questioned the utility of a post-radioactive iodine total body scan for patients with thyroid cancer confined to the thyroid (Cailleux A F, Baudin E, Travagli J P, Ricard M, Schlumberger M. Is diagnostic iodine-131 scanning useful after total thyroid ablation for differentiated thyroid cancer? J Clin Endocrinol Metab 2000; 85(1):175-8). The vast majority of patients will have some uptake of iodine in the neck region due to a few remaining thyroid cells, and a dark spot in the region of the bladder may also be visualized on the scan.

In addition, female patients are recommended to avoid becoming pregnant for the first 6-12 months following a radioactive iodine treatment. Although there is no evidence of an increased risk of birth defects in women who do become pregnant in this time period, there is a slightly higher rate of miscarriage in the year following radioactive iodine treatment for thyroid cancer. Hence, birth control is recommended for women in the reproductive age group. As small amounts of radioactive iodine may remain in the body for several weeks after the radioactive iodine treatment, breast feeding should also be discontinued in nursing mothers.

### Radioactive Iodine Monitoring

The need for monitoring ¹³¹I exposure is therefore at least twofold—first as a biomonitoring tool for triaging victims of nuclear terrorism; and more routinely, biomonitoring is important for thyroid cancer patients exposed to ¹³¹I ablation therapy.

### SUMMARY

One aspect of the invention relates to a method for detecting by mass spectrometry the presence or amount of organified radioiodine, such as radioactive thyroxine, in a sample. In certain embodiments, the sample is serum or plasma. In certain embodiments, the method is a radioiodine dosimetry method which provides a measurement of a patient's internal exposure to radioactive iodine. In certain embodiments, the method is a useful indicator of residual, recurrent or metastatic thyroid cancer in patients who have been previously treated with a thyroidectomy. In certain embodiments, the method is a useful indicator of a patient's exposure to radiation. In certain embodiments, the method comprises the step of obtaining radioactive thyroxine measures by mass spectrometry at various time points following ¹³¹I therapy, for patients receiving ¹³¹I scans with differentiated thyroid cancer, or following nuclear exposure, for patients who have been exposed to radiation. In certain embodiments, the method provides a precise and specific, powerful diagnostic tool in the management of radiation casualties based on specific radiation diagnostics, including an individualized biodosimetry tool and predictive biomarker assay to assess early and/or delayed injury, with the ultimate goal of restoring physiological function and improving survival and other relevant clinical outcomes. Additional aspects, embodiments, and advantages of the invention are discussed below in detail.

### BRIEF DESCRIPTION OF THE FIGURES

FIG. 1 is a table containing estimations of time necessary for isolation following

FIG. 2 is a table containing total exposure estimates based on ¹³¹I dose administered.

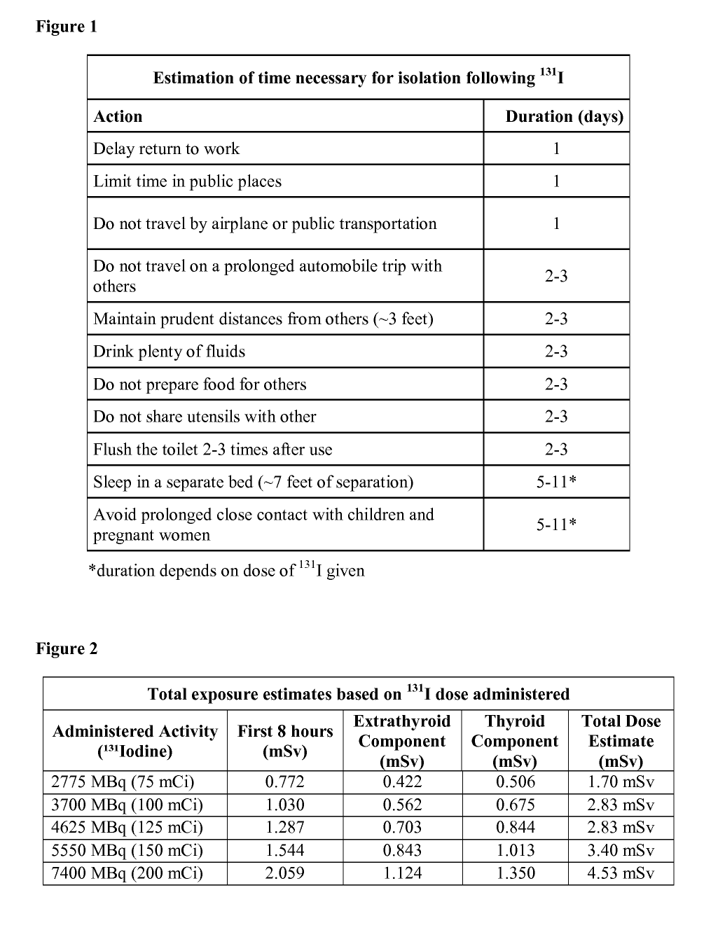

### DETAILED DESCRIPTION

One aspect of the invention relates to a biodosimetry method to measure organified radioiodine and applications of this method to clinical practice. Such methods utilize mass spectrometry for detecting and quantifying organified radioiodine, such as radioactive thyroxine, in a test sample. In certain aspects the method involves ionizing organified radioiodine, such as radioactive thyroxine, and detecting the resulting ion(s) by mass spectrometry. In certain embodiments, the method simultaneously detects thyroxine (the endogenous isotope). Applications of these methods, such as the use of radioiodine-labeled iodothyronines as biomarkers of internal radiation exposure, thereby allowing physicians to appropriately respond and ameliorate damage and long-term effects of radiation exposure, such as cancer, are also disclosed.

### Dosimetry

As noted above, radioiodine (¹³¹I) therapy is effective for the ablation of benign remnant thyroid tissue and in patients with differentiated thyroid carcinoma (DTC) after total or near-total thyroidectomy to eradicate remaining cancerous cells, either in the thyroid bed or at metastatic sites. The efficacy of ¹³¹I for both scanning and treatment depends individually on several variables related to the patient, tumor and dose of ¹³¹I. This is due to selective ¹³¹I uptake by thyroid cells; successful ablation of thyroid cancer depends individually on the extent of surgery, size, pathology, number and type of tumor, the absorbed ¹³¹I dose by any remaining cancer cells. Furthermore, thyroidal ¹³¹I uptake varies with patient dietary intake, iodine sufficiency, age, sex, and health status. Therefore, dosimetry is essential because it answers questions concerning biodistribution, since the biological half-life of radioactive iodine differs substantially between patients and even within the same patient as the median effective half-life is 14 hours (North D L, Shearer D R, Hennessey J V, Donovan G L. Effective half-life of 131I in thyroid cancer patients. Health Phys. 2001 September; 81(3):325-9). Dosimetry-based personalized treatment can prevent sub-optimal administration, which could entail further ¹³¹I treatment, as well as excessive administration, which could cause radiation toxicity. Currently, the average rate of successful ablation is 80%, suggesting that additional variables may increase ¹³¹I uptake and its effective half-life, contributing to a higher radiation dose and more effective treatment.

### Thyroglobulin Tests

The American Thyroid Association (ATA) and European Thyroid Association (ETA) identify patients who are free of tumor after thyroid ablation by similar criteria: no clinical evidence of tumor with no ¹³¹I uptake outside the thyroid bed on the post-treatment whole body ¹³¹I scan, negative neck ultrasonography, undetectable serum thyroglobulin (Tg) levels during TSH suppression, and stimulation without interfering anti-Tg antibodies. Diagnostic whole body scanning is not recommended for low-risk patients because it has low sensitivity, whereas neck ultrasonography combined with Tg is more cost-effective and more accurate. The weakest link in the follow-up chain is the measurement of Tg. Interfering antibodies and a variety of other factors produce misleading information, creating significant variation among Tg assays. There are numerous Tg assays with apparently similar low functional sensitivities. However, these Tg assays are not necessarily clinically equivalent as the analytical accuracy (as opposed to precision) may also differ significantly (Tg<0.1 μg/L in one assay may not have the same clinical implications as a Tg<0.1 μg/L measured by another method). The lack of clinical diagnostic efficacy information is one of the main problems with our current follow-up paradigms using many contemporary Tg assays. To resolve these problems, a person's Tg must be obtained under identical degrees of TSH suppression or stimulation and measured in the same laboratory by the same assay, which is more likely to produce comparable results over time. Nevertheless, TSH-suppressed (basal) Tg levels in the range of 0.5-1 μg/L often fail to identify residual tumor, a problem improved with levothyroxine withdrawal (Tg-off) or recombinant human TSH stimulation (rhTSH-Tg). Still, the positive predictive value (PPV) of the initial Tg-off or first rhTSH-Tg result is only about 40 to 50%, although it improves to 80% if the Tg is rising or the patient undergoes repetitive testing over several years. Thus, almost all the patients with residual tumor were not identified with rhTSH-Tg cut-offs of 1 μg/L (PPV 6.5%) or 2 μg/L (PPV 16.6%). A more sensitive test detects minor Tg elevations of uncertain significance placing patients at risk of more extensive testing and unnecessary treatment.

### Radioactive Iodine Uptake

The thyroid's avidity for iodide and the measurement of ¹³¹I uptake gives a clinician an indirect measurement of thyroxine production. Activity measured following oral administration of the radioiodide is characterized by an early, rapid uptake phase followed by a plateau of radioactivity in the gland that is most conveniently measured at 24 hours. The fractional uptake of a given amount of ¹³¹I depends on the production rate of thyroid hormone, thyroid iodide stores, and dietary iodide intake. Iodide stores and dietary iodide are usually closely inter-related, but since the dietary iodide is only 150 to 600 μg/day, pharmacologic iodide loads (certain drugs or dyes) may artificially reduce the radioiodine uptake to very low values.

Despite its susceptibility to these hazards, the radioactive iodine uptake is an excellent adjunctive test. As with the estimation of thyroxine, there is overlap in various states of thyroid function as assessed by the radioactive iodine test. Major disadvantages are cost and the requirement for at least two visits to the hospital. For example, if lymphocytic thyroiditis with spontaneously resolving hyperthyroidism is suspected, low iodine uptake during the hyperthyroid phase will greatly assist in diagnosis. In addition, if a patient is hyperthyroid from ingesting pharmacological doses of thyroid hormone, or if the patient has the rare struma ovarii with hyperthyroidism, the radioactive iodine uptake will again be low. In the latter case, scanning of the abdomen will reveal the excessive thyroxine production site. In patients with symptoms of hyperthyroidism and nondiagnostic studies of thyroid hormone concentration, a significant elevation of the ¹³¹I uptake helps establish the diagnosis.

### Radiolabeled Iodothyronines

It has previously been shown that following the administration of ¹³¹I to patients, secreted radiolabeled iodothyronines can be detected in the circulation. The radiolabeled iodothyronines represent radioactive iodine trapped by thyroid tissue, synthesized into iodothyronines, and secreted into the bloodstream. The amount of radiolabeled iodothyronines detected in the circulation of a patient with differentiated thyroid cancer following a thyroidectomy should reflect the amount of residual thyroid cancer, especially in patients who have had a thyroidectomy and then treated with radioactive iodine. During the monitoring of patients for residual disease, current tests routinely employed include clinical examination, neck ultrasound, perhaps radiologic studies such as CT or PET scans, periodic ¹³¹I scans, and periodic measurement of serum Tg both in the basal and stimulated state.

The methods disclosed herein provide a superior alternative to detection of biological levels of ¹³¹I exposure, allowing a more accurate biomarker of disease than Tg capable of detecting and measuring very low concentrations in humans. Furthermore, the LC/MS/MS detection of ¹³¹I-T4 discussed below can provide a superior alternative to Tg testing for an estimate of residual differentiated thyroid cancer remnants and metastases. Present techniques of detecting residual thyroid cancer have limitations: radioactive scans are sensitive but not specific, and a sonogram of the neck may not detect small residual cancer deposits; furthermore, cervical nodes may be enlarged but still be benign. Additional radiologic studies such as CT or PET scans also require a lesion to be at least about 1 cm to be detected, and these scans have frequent false-positive results. Measuring serum Tg levels is helpful, but about 20% of patients have Tg antibodies that preclude an accurate determination of Tg levels. In certain embodiments, the methods disclosed herein address these shortcomings.

### Selected Methods

As noted above, in certain embodiments, the ¹³¹I dosimetry methods described herein are based on ¹³¹I organification into thyroxine. Specifically, once internalized (e.g., by being ingested, such as by being introduced through diet or drinking water, being inhaled, or being absorbed through the skin), ¹³¹I is incorporated by the thyrocytes into iodothyronines to form, for example, ¹³¹I-thyroxine and ¹³¹I-triiodothyronine. In certain embodiments, the methods disclosed herein are sensitive methods to detect and quantify ¹³¹I-thyroxine and ¹³¹I-triiodothyronine in humans. In other embodiments, the methods disclosed herein relate to the measuring of ¹³¹I-thyroxine as a biomarker of residual thyroid tissue in patients with benign hyperactive thyroid and patients with thyroid cancer treated with radioactive iodine therapy. In yet other embodiments, the methods disclosed herein may be used to determine the efficacy of ¹³¹I therapy in patients with DTC. It may also serve as a biomarker of exposure; if a person was exposed to an unknown amount of radiation, not for therapeutic purposes, the methods disclosed herein can establish exposure and its extent.

In certain embodiments, ¹³¹I-thyroxine concentrations will be determined within a specific volume. If the concentration is determined repeatedly over time, the “area under the curve” can be estimated for the entire dwell-time of the beta- and gamma-emitting isotope and enable more precise in vivo determination of iodine concentrations. ¹³¹I-thyroxine-based, patient-specific lesion dosimetry based on sequential ¹³¹I-thyroxine biomarker measurements can then be used to obtain cumulative activity.

In certain embodiments, the dosimetry methods described herein will provide an accurate and powerful diagnostic tool in the management of radiation casualties based on specific radiation diagnostics, including an individualized biodosimetry tool and predictive biomarker assay to assess early and/or delayed injury. Following potassium iodide treatment, and days after exposure any detected ¹³¹I-thyroxine will indicate internal exposure to ¹³¹I radiation in a dose-specific manner.

For example, one aspect of the invention relates to a method comprising the steps of:

(a) preparing an analytical sample from a biological sample comprising radioactive thyroxine;

(b) ionizing at least a portion of the analytical sample using a mass spectrometer, thereby generating at least one radioactive thyroxine derived ion;

(c) quantifying the amount of the at least one radioactive thyroxine derived ion; and

(d) determining the amount of radioactive thyroxine in the biological sample based on the amount of said at least one radioactive thyroxine derived ion;

wherein radioactive thyroxine is represented by

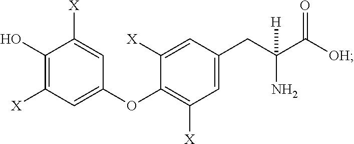

and X is, independently for each occurrence, ¹²⁷I, ¹²⁹I or ¹³¹I, provided that at least one instance of X is ¹³¹I or ¹²⁹I.

In certain embodiments, the present invention relates to any of the aforementioned methods, wherein the biological sample is selected from the group consisting of blood, plasma, serum, urine, cerebrospinal fluid, amniotic fluid and saliva.

In certain embodiments, the present invention relates to any of the aforementioned methods, wherein the biological sample is serum or plasma. In certain embodiments, the present invention relates to any of the aforementioned methods, wherein the biological sample is serum. In certain embodiments, the present invention relates to any of the aforementioned methods, wherein the biological sample is plasma.

In certain embodiments, the present invention relates to any of the aforementioned methods, wherein the biological sample was taken from a subject exposed to radiation.

In certain embodiments, the present invention relates to any of the aforementioned methods, wherein the biological sample was taken from a post-operative thyroidectomy patient.

In certain embodiments, the present invention relates to any of the aforementioned methods, wherein the biological sample was taken from a subject previously treated with ablation therapy.

In certain embodiments, the present invention relates to any of the aforementioned methods, wherein the biological sample is taken from a subject who was exposed to radiation.

In certain embodiments, the present invention relates to any of the aforementioned methods, wherein the method further comprises the step of determining the urgency of treating the subject relative to other subjects who have also been exposed to radiation.

In certain embodiments, the present invention relates to any of the aforementioned methods, wherein the method further comprises the step of determining if due to residual radioactivity that the patient needs to be kept in isolation.

In certain embodiments, the present invention relates to any of the aforementioned methods, wherein the method further comprises the steps of waiting an amount of time and repeating steps (a)-(d) with a second biological sample comprising radioactive thyroxine taken from the same source as the original biological sample.

In certain embodiments, the present invention relates to any of the aforementioned methods, wherein the method takes an amount of time to complete; and the amount of time to complete the method is less than about one hour. In certain embodiments, the present invention relates to any of the aforementioned methods, wherein the method takes an amount of time to complete; and the amount of time to complete the method is less than about thirty minutes. In certain embodiments, the present invention relates to any of the aforementioned methods, wherein the method takes an amount of time to complete; and the amount of time to complete the method is less than about fifteen minutes.

In certain embodiments, the present invention relates to any of the aforementioned methods, wherein the method further comprises the steps of waiting an amount of time and repeating steps (a)-(d) with a second sample comprising radioactive thyroxine taken from the same source as the sample; and comparing the amount of radioactive thyroxine in the sample to the amount of radioactive thyroxine in the second sample.

In certain embodiments, the present invention relates to any of the aforementioned methods, wherein the step of preparing the analytical sample comprises the step of deproteinating the biological sample.

In certain embodiments, the present invention relates to any of the aforementioned methods, wherein the step of deproteinating the biological sample comprises the steps of adding solvent to the biological sample, and mixing and centrifuging the resulting solution.

In certain embodiments, the present invention relates to any of the aforementioned methods, wherein the step of deproteinating the biological sample comprises adding an agent selected from the group consisting of methanol, ethanol and salt to the biological sample.

In certain embodiments, the present invention relates to any of the aforementioned methods, wherein the step of preparing the analytical sample comprises the step of separating the radioactive thyroxine from the analytical sample.

In certain embodiments, the present invention relates to any of the aforementioned methods, wherein the step of separating the radioactive thyroxine from the analytical sample comprises the use of a C-18 chromatography column.

In certain embodiments, the present invention relates to any of the aforementioned methods, wherein the biological sample has a volume of about 1 μL to about 500 μL. In certain embodiments, the present invention relates to any of the aforementioned methods, wherein the biological sample has a volume of about 50 μL to about 400 μL. In certain embodiments, the present invention relates to any of the aforementioned methods, wherein the biological sample has a volume of about 100 μL to about 300 μL. In certain embodiments, the present invention relates to any of the aforementioned methods, wherein the biological sample has a volume of about 200 μL.

In certain embodiments, the present invention relates to any of the aforementioned methods, wherein the time to complete the method is less than about one hour.

In certain embodiments, the present invention relates to any of the aforementioned methods, wherein the radioactive thyroxine is present in the biological sample at a concentration between about 1 pg/mL and 1,000 pg/mL. In certain embodiments, the present invention relates to any of the aforementioned methods, wherein the radioactive thyroxine is present in the biological sample at a concentration between about 1 pg/mL and 100 pg/mL. In certain embodiments, the present invention relates to any of the aforementioned methods, wherein the radioactive thyroxine is present in the biological sample at a concentration between about 1 pg/mL and 10 pg/mL. In certain embodiments, the present invention relates to any of the aforementioned methods, wherein the radioactive thyroxine is present in the biological sample at a concentration of about 1 pg/mL.

In certain embodiments, the present invention relates to any of the aforementioned methods, wherein the mass spectrometer is a quadrupole time-of-flight mass spectrometer, matrix-assisted laser desorption/ionization time-of-flight spectrometer, ion trap time-of-flight mass spectrometer, time-of-flight mass spectrometer or a triple quadrupole mass spectrometer.

In certain embodiments, the present invention relates to any of the aforementioned methods, wherein said step of ionizing the analytical sample comprises an ionization technique selected from the group consisting of photoionization, electrospray ionization, atmospheric pressure chemical ionization, and electron capture ionization.

In certain embodiments, the present invention relates to any of the aforementioned methods, wherein said ionization technique is electrospray ionization.

In certain embodiments, the present invention relates to any of the aforementioned methods, wherein said ionization is performed in the positive mode.

In certain embodiments, the present invention relates to any of the aforementioned methods, wherein said ionization is performed in the negative mode.

In certain embodiments, the present invention relates to any of the aforementioned methods, wherein the detection and quantification of the at least one radioactive thyroxine derived ion comprises multiple reaction-monitoring analysis.

In certain embodiments, the present invention relates to any of the aforementioned methods, wherein the detection and quantification of the at least one radioactive thyroxine derived ion comprises selected ion monitoring.

In certain embodiments, the present invention relates to any of the aforementioned methods, wherein the biological sample further comprises non-radioactive thyroxine; the step of ionizing the analytical sample using a mass spectrometer further generates at least one non-radioactive thyroxine derived ion; and the method further comprises the step of quantifying the at least one non-radioactive thyroxine derived ion in the biological sample, thereby determining the amount of non-radioactive thyroxine in the biological sample.

In certain embodiments, the present invention relates to any of the aforementioned methods, wherein the method sequentially quantifies the at least one radioactive thyroxine derived ion and the at least one non-radioactive thyroxine derived ion.

In certain embodiments, the present invention relates to any of the aforementioned methods, wherein the biological sample further comprises one or more additional radioactive iodothyronine(s); and the step of ionizing the analytical sample using a mass spectrometer further generates one or more radioactive iodothyronine derived ion(s).

In certain embodiments, the present invention relates to any of the aforementioned methods, wherein the step of quantifying the at least one radioactive thyroxine derived ion also quantifies the one or more additional radioactive iodothyronine(s) ions in the analytical sample; and the method further comprises determining the amount of radioactive iodothyronine(s) in the biological sample based on the amount of the one or more radioactive iodothyronine(s) derived ion(s).

In certain embodiments, the present invention relates to any of the aforementioned methods, wherein the method further comprises the step of quantifying the one or more radioactive iodothyronine derived ion(s) in the analytical sample; and the method further comprises determining the amount of radioactive iodothyronine(s) in the biological sample based on the amount of the one or more radioactive iodothyronine(s) derived ion(s).

In certain embodiments, the present invention relates to any of the aforementioned methods, wherein the one or more additional radioactive iodothyronine(s) comprise radioactive triiodothyronine; the radioactive triiodothyronine is represented by

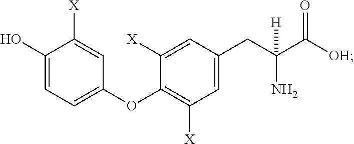

and each X is, independently for each occurrence, ¹²⁷I, ¹²⁹I or ¹³¹I, provided that at least one instance X is ¹³¹I or ¹²⁹I.

In certain embodiments, the present invention relates to any of the aforementioned methods, wherein the step of preparing the analytical sample comprises adding an internal standard to the biological sample.

In certain embodiments, the present invention relates to any of the aforementioned methods, wherein the internal standard is deuterated thyroxine.

In certain embodiments, the present invention relates to any of the aforementioned methods, wherein the step of ionizing the analytical sample using a mass spectrometer further generates at least one deuterated thyroxine derived ion; and the method further comprises the step of quantifying the at least one deuterated thyroxine derived ion in the analytical sample.

In certain embodiments, the present invention relates to any of the aforementioned methods, wherein the method sequentially quantifies the at least one radioactive thyroxine derived ion and the at least one deuterated thyroxine derived ion.

In certain embodiments, the present invention relates to any of the aforementioned methods, wherein the one or more radioactive thyroxine derived ions has a mass/charge ratio (m/z) of between about 780 and about 795.

In certain embodiments, the present invention relates to any of the aforementioned methods, wherein the one or more radioactive thyroxine derived ions has a mass/charge ratio of about 776.87, about 780.87, about 784.87, about 788.87 or about 792.87.

Another aspect of the invention relates to a method of instructing an analysis of a biological sample that contains radioactive thyroxine, the method comprising providing instructions to prepare an analytical sample according to step (a) above; to ionize, detect and quantify the one or more radioactive thyroxine derived ions according to steps (b) and (c) of above; and to determine the amount of radioactive thyroxine in the biological same according to step (d) above.

### Selected Systems

One aspect of the invention relates to a system for the mass spectrometric analysis of a sample containing radioactive thyroxine, comprising: reagents for preparing an analytical sample from the biological sample; and a mass spectrometer. In certain embodiments, the present invention relates to any of the aforementioned systems, wherein the mass spectrometer is a liquid chromatography-tandem mass spectrometer, or any of the mass spectrometers discussed above. In certain embodiments, the present invention relates to any of the aforementioned system, further comprising an internal standard (such as deuterated thyroxine).

### Selected Kits

This invention also provides kits for conveniently and effectively assessing the amount of radioactive thyroxine in a sample. One aspect of the invention relates to a kit for use in mass spectrometric analysis of a biological sample comprising radioactive thyroxine, comprising: reagents for preparing an analytical sample from the biological sample; and instructions for analyzing the analytical sample. In certain embodiments, the present invention relates to any of the aforementioned kits, further comprising an internal standard. In certain embodiments, the present invention relates to any of the aforementioned kits, further comprising reagents for separating the radioactive thyroxine from the analytical sample. In certain embodiments, the present invention relates to any of the aforementioned kits, further comprising: (a) mobile phase solutions; (b) a chromatography column; and (c) a quality control specimen. In certain embodiments, the present invention relates to any of the aforementioned kits, further comprising: reagents for analyzing the radioactive thyroxine separated using a mass spectrometer.

A kit of the invention may include instructions in any form that are provided in connection with the methods of the invention in such a manner that one of ordinary skill in the art would recognize that the instructions are to be associated with the methods of the invention. In some cases, the instructions may also include instructions for the use of the mass spectrometer. The instructions may be provided in any form recognizable by a user as a suitable vehicle for containing such instructions; for example, written or published, verbal, audible (e.g., telephonic), digital, optical, visual (e.g., videotape, DVD, etc.) or electronic communications (including Internet or web-based communications), provided in any manner.

### Definitions

All definitions, as defined and used herein, should be understood to control over dictionary definitions, definitions in documents incorporated by reference, and/or ordinary meanings of the defined terms.

For purposes of this invention, the chemical elements are identified in accordance with the Periodic Table of the Elements, CAS version, Handbook of Chemistry and Physics, 67th Ed., 1986-87, inside cover.

The articles “a” and “an” are used herein to refer to one or to more than one (i.e., to at least one) of the grammatical object of the article. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or, when used in the claims, “consisting of” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of” “only one of” or “exactly one of” “Consisting essentially of” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification, all transitional phrases such as “comprising,” “including,” “carrying,” “having,” “containing,” “involving,” “holding,” “composed of” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As used herein, an “adduct” is a species formed by the union of two molecules held together by one or more covalent and/or non-covalent bonds.

As used herein, “biological sample” refers to any sample from a biological source. As used herein, “body fluid” means any fluid that can be isolated from the body of an individual. For example, “body fluid” may include blood, plasma, serum, bile, saliva, urine, tears, perspiration, and the like.

As used herein, “derivatizing” means reacting two molecules to form a new molecule. Derivatizing agents may include Cookson-type reagents (e.g., 4-substituted 1,2,4-triazoline-3,5-diones; TAD); isothiocyanate groups, dinitro-fluorophenyl groups, nitrophenoxycarbonyl groups, and/or phthalaldehyde groups. In certain embodiments, derivatization is performed using methods such as those disclosed in, for example, Vreeken, et., al., Biol. Mass Spec. 22:621-632; Yeung B, et al., J Chromatogr. 1993, 645(1):115-23; Higashi T, et al., Biol Pharm Bull. 2001, 24(7):738-43; or Higashi T, et al., J Pharm Biomed Anal. 2002, 29(5):947-55. In certain embodiments the derivatizing agents are Cookson-type reagents. Exemplary derivatizing reagents include 4-phenyl-1,2,4-triazoline-3,5-dione (PTAD); 4′-carboxyphenyl-TAD; 4-[4-(6-methoxy-2-benzoxazolyl)phenyl]-1,2,4-triazoline-3,5-dione (MBOTAD); 4-[2-(6,7-dimethoxy-4-methyl-3-oxo-3,4-dihydroquinoxalyl)ethyl]-1,2,4-triazoline-3,5-dione (DMEQTAD); 4-nitrophenyl-TAD; 4-pentafluorophenyl-TAD; 4-ferrocenylethyl-TAD; 4-quarternaryamine-TAD; and the like. In certain embodiments derivatization is performed prior to chromatography; however in other embodiments derivatization is performed after chromatography, for example using methods similar to those described in Vreeken, et., al., Biol. Mass Spec. 22:621-632. In certain embodiments of the methods disclosed herein, the radioactive thyroxine is not derivatized prior to mass spectrometry.

As used herein, “chromatography” refers to a process in which a chemical mixture carried by a liquid or gas is separated into components as a result of differential distribution of the chemical entities as they flow around or over a stationary liquid or solid phase.

As used herein, “liquid chromatography” (LC) means a process of selective retardation of one or more components of a fluid solution as the fluid uniformly percolates through a column of a finely divided substance, or through capillary passageways. The retardation results from the distribution of the components of the mixture between one or more stationary phases and the bulk fluid, (i.e., mobile phase), as this fluid moves relative to the stationary phase(s). “Liquid chromatography” includes reverse phase liquid chromatography (RPLC), high performance liquid chromatography (HPLC) and high turbulence liquid chromatography (HTLC).

As used herein, the term “HPLC” or “high performance liquid chromatography” refers to liquid chromatography in which the degree of separation is increased by forcing the mobile phase under pressure through a stationary phase, typically a densely packed column.

As used herein, the term “gas chromatography” refers to chromatography in which the sample mixture is vaporized and injected into a stream of carrier gas (as nitrogen or helium) moving through a column containing a stationary phase composed of a liquid or a particulate solid and is separated into its component compounds according to the affinity of the compounds for the stationary phase

As used herein, “mass spectrometry” (MS) refers to an analytical technique to identify compounds by their mass. MS technology generally includes (1) ionizing the compounds to form charged compounds; and (2) detecting the molecular weight of the charged compound and calculating a mass-to-charge ratio (m/z). The compound may be ionized and detected by any suitable means. A “mass spectrometer” generally includes an ionizer and an ion detector. See, e.g., U.S. Pat. No. 6,204,500, entitled “Mass Spectrometry From Surfaces;” U.S. Pat. No. 6,107,623, entitled “Methods and Apparatus for Tandem Mass Spectrometry;” U.S. Pat. No. 6,268,144, entitled “DNA Diagnostics Based On Mass Spectrometry;” U.S. Pat. No. 6,124,137, entitled “Surface-Enhanced Photolabile Attachment And Release For Desorption And Detection Of Analytes;” Wright et al., Prostate Cancer and Prostatic Diseases 2:264-76 (1999); and Merchant and Weinberger, Electrophoresis 21:1164-67 (2000).

The term “electron ionization” as used herein refers to methods in which an analyte of interest in a gaseous or vapor phase interacts with a flow of electrons. Impact of the electrons with the analyte produces analyte ions, which may then be subjected to a mass spectrometry technique.

The term “chemical ionization” as used herein refers to methods in which a reagent gas (e.g., ammonia) is subjected to electron impact, and analyte ions are formed by the interaction of reagent gas ions and analyte molecules.

The term “fast atom bombardment” as used herein refers to methods in which a beam of high energy atoms (often Xe or Ar) impacts a non-volatile sample, desorbing and ionizing molecules contained in the sample. Test samples are dissolved in a viscous liquid matrix such as glycerol, thioglycerol, m-nitrobenzyl alcohol, 18-crown-6 crown ether, 2-nitrophenyloctyl ether, sulfolane, diethanolamine, and triethanolamine.

The term “field desorption” as used herein refers to methods in which a non-volatile test sample is placed on an ionization surface, and an intense electric field is used to generate analyte ions.

The term “ionization” as used herein refers to the process of generating an analyte ion having a net electrical charge equal to one or more electron units. Negative ions are those having a net negative charge of one or more electron units, while positive ions are those having a net positive charge of one or more electron units.

The term “operating in negative ion mode” refers to those mass spectrometry methods where negative ions are detected. The term “operating in positive ion mode” refers to those mass spectrometry methods where positive ions are detected.

The term “desorption” as used herein refers to the removal of an analyte from a surface and/or the entry of an analyte into a gaseous phase.

As used herein, “iodothyronines” refers to thyroxine and triiodothyronine, as well as to metabolites derived from thyroxine and triiodothyronine via the peripheral enzymatic removal of iodines from the thyroxine nucleus.

The term “thyroxine” or “T4” as used here in refers to the compound represented by

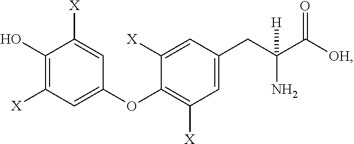

wherein each X is ¹²⁷I. The term “radioactive thyroxine” as used herein refers to

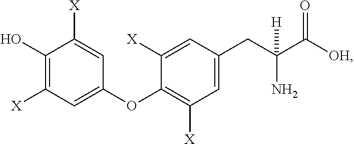

wherein each X is ¹²⁷I, ¹²⁹I or ¹³¹I, provided that at least one X is ¹³¹I or ¹²⁹I.

The term “triiodothyronine” or “T3” as used herein refers to the compound represented by

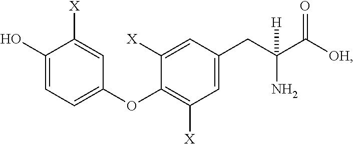

wherein each X is ¹²⁷I. The term “radioactive triiodothyronine” as used herein refers to

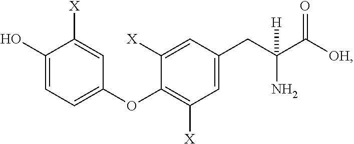

wherein each X is ¹²⁷I, ¹²⁹I or ¹³¹I, provided that at least one X is ¹³¹I or ¹²⁹I.

### Test Samples

Suitable test samples include any test sample that may contain the analyte of interest. In some embodiments, a sample is a biological sample; that is, a sample obtained from any biological source, such as an animal, a cell culture, an organ culture, etc. In certain embodiments, samples are obtained from a mammalian animal, such as a dog, cat, horse, etc. Exemplary mammalian animals are primates, most preferably humans. Exemplary samples include blood, plasma, serum, hair, muscle, urine, saliva, tear, cerebrospinal fluid, amniotic fluid or other tissue sample. Such samples may be obtained, for example, from a patient, that is, a living person presenting oneself in a clinical setting for diagnosis, prognosis, or treatment of a disease or condition. The test sample may be obtained from a patient, for example, blood serum.

### Sample Preparation for Mass Spectrometry

Methods may be used prior to mass spectrometry to enrich radioactive thyroxine relative to other components in the sample, or to increase the concentration of the radioactive thyroxine in the sample. Such methods include, for example, filtration, centrifugation, thin layer chromatography (TLC), electrophoresis including capillary electrophoresis, affinity separations including immunoaffinity separations, extraction methods including ethyl acetate extraction and methanol extraction, and the use of chaotropic agents or any combination of the above or the like.

Samples may be processed or purified to obtain preparations that are suitable for analysis by mass spectrometry. Such purification will usually include chromatography, such as liquid chromatography, and may also often involve an additional purification procedure that is performed prior to chromatography. Various procedures may be used for this purpose depending on the type of sample or the type of chromatography. Examples include filtration, extraction, precipitation, centrifugation, delipidization, dilution, combinations thereof and the like. Protein precipitation (i.e., deproteination) is one method of preparing a liquid biological sample, such as serum or plasma, for chromatography. Such protein precipitation methods are well known in the art, for example, Polson et al., Journal of Chromatography B 785:263-275 (2003), describes protein precipitation methods suitable for use in the methods of the invention. Protein precipitation may be used to remove most of the protein from the sample leaving radioactive thyroxine soluble in the supernatant. The samples can be centrifuged to separate the liquid supernatant from the precipitated proteins. The resultant supernatant can then be applied to liquid chromatography and subsequent mass spectrometry analysis. In one embodiment of the invention, the protein precipitation involves adding one volume of the liquid sample (e.g., plasma) to about four volumes of methanol. In another embodiment, the protein precipitation involves adding two volumes of liquid sample (e.g., plasma) to about three volumes of methanol. In certain embodiments of protein precipitation, the methanol solution contains an internal standard and/or the adduct. In certain embodiments, the use of protein precipitation obviates the need for high turbulence liquid chromatography (“HTLC”) or on-line extraction prior to HPLC and mass spectrometry. Accordingly in such embodiments, the method involves (1) performing a protein precipitation of the sample of interest; and (2) loading the supernatant directly onto the HPLC-mass spectrometer without using on-line extraction or high turbulence liquid chromatography (“HTLC”).

### Liquid Chromatography

Generally, chromatography may be performed prior to mass spectrometry; the chromatography may be liquid chromatography, such as high performance liquid chromatography (HPLC).

Liquid chromatography (LC) including high-performance liquid chromatography (HPLC) rely on relatively slow, laminar flow technology. Traditional HPLC analysis relies on column packings in which laminar flow of the sample through the column is the basis for separation of the analyte of interest from the sample. The skilled artisan will understand that separation in such columns is a diffusional process. HPLC has been successfully applied to the separation of compounds in biological samples. But a significant amount of sample preparation is required prior to the separation and subsequent analysis with a mass spectrometer (MS), making this technique labor intensive. In addition, most HPLC systems do not utilize the mass spectrometer to its fullest potential, allowing only one HPLC system to be connected to a single MS instrument, resulting in lengthy time requirements for performing a large number of assays.

Various methods have been described involving the use of HPLC for sample clean-up prior to mass spectrometry analysis. See, e.g., Taylor et al., Therapeutic Drug Monitoring 22:608-12 (2000) (manual precipitation of blood samples, followed by manual C18 solid phase extraction, injection into an HPLC for chromatography on a C18 analytical column, and MS/MS analysis); and Salm et al., Clin. Therapeutics 22 Suppl. B:B71-B85 (2000) (manual precipitation of blood samples, followed by manual CIS solid phase extraction, injection into an HPLC for chromatography on a C18 analytical column, and MS/MS analysis).

One of skill in the art can select HPLC instruments and columns that are suitable for use in the invention. The chromatographic column typically includes a medium (i.e., a packing material) to facilitate separation of chemical moieties (i.e., fractionation). The medium may include minute particles. The particles include a bonded surface that interacts with the various chemical moieties to facilitate separation of the chemical moieties. One suitable bonded surface is a hydrophobic bonded surface such as an alkyl bonded surface. Alkyl bonded surfaces may include C-4, C-8, or C-18 bonded alkyl groups, preferably C-18 bonded groups. The chromatographic column includes an inlet port for receiving a sample and an outlet port for discharging an effluent that includes the fractionated sample. In one embodiment, the sample (or pre-purified sample) is applied to the column at the inlet port, eluted with a solvent or solvent mixture, and discharged at the outlet port. Different solvent modes may be selected for eluting the analytes of interest. For example, liquid chromatography may be performed using a gradient mode, an isocratic mode, or a polytyptic (i.e., mixed) mode. During chromatography, the separation of materials is effected by variables such as choice of eluent (also known as a “mobile phase”), choice of gradient elution and the gradient conditions, temperature, etc.

In certain embodiments, an analyte may be purified by applying a sample to a column under conditions where the analyte of interest is reversibly retained by the column packing material, while one or more other materials are not retained. In these embodiments, a first mobile phase condition can be employed where the analyte of interest is retained by the column, and a second mobile phase condition can subsequently be employed to remove retained material from the column, once the non-retained materials are washed through. Alternatively, an analyte may be purified by applying a sample to a column under mobile phase conditions where the analyte of interest elutes at a differential rate in comparison to one or more other materials. Such procedures may enrich the amount of one or more analytes of interest relative to one or more other components of the sample.

Recently, high turbulence liquid chromatography (“HTLC”), also called high throughput liquid chromatography, has been applied for sample preparation prior to analysis by mass spectrometry. See, e.g., Zimmer et al., J. Chromatogr. A 854:23-35 (1999); see also, U.S. Pat. Nos. 5,968,367; 5,919,368; 5,795,469; and 5,772,874. Traditional HPLC analysis relies on column packings in which laminar flow of the sample through the column is the basis for separation of the analyte of interest from the sample. The skilled artisan will understand that separation in such columns is a diffusional process. In contrast, it is believed that turbulent flow, such as that provided by HTLC columns and methods, may enhance the rate of mass transfer, improving the separation characteristics provided. In some embodiments, high turbulence liquid chromatography (HTLC), alone or in combination with one or more purification methods, may be used to purify the sample prior to mass spectrometry. In such embodiments samples may be extracted using an HTLC extraction cartridge which captures the analyte, then eluted and chromatographed on a second HTLC column or onto an analytical HPLC column prior to ionization. Because the steps involved in these chromatography procedures can be linked in an automated fashion, the requirement for operator involvement during the purification of the analyte can be minimized. In certain embodiments of the method, samples are subjected to protein precipitation as described above prior to loading on the HTLC column; in alternative embodiments, the samples may be loaded directly onto the HTLC without being subjected to protein precipitation.

### Detection and Quantization by Mass Spectrometry

Disclosed are mass spectrometric methods for detecting the presence or amount of radioactive thyroxine in a sample. Mass spectrometry may be performed using a mass spectrometer which includes an ion source for ionizing the fractionated sample and creating charged molecules for further analysis. For example ionization of the sample may be performed by electrospray ionization (ESI), atmospheric pressure chemical ionization (APCI), atmospheric pressure photoionization (APPI), photoionization, electron ionization, fast atom bombardment (FAB)/liquid secondary ionization (LSIMS), matrix-assisted laser desorption/ionization (MALDI), field ionization, field desorption, thermospray/plasmaspray ionization, and particle beam ionization. The skilled artisan will understand that the choice of ionization method can be determined based on the analyte to be measured, type of sample, the type of detector, the choice of positive versus negative mode, etc.

In certain embodiments, the following mass spectrometers can be used: any tandem-mass spectrometer, including quadrupole time-of-flight (QTOF), matrix-assisted laser desorption/ionization time-of-flight (MALDI/TOF), hybrid quadrupole-linear ion trap mass spectrometers and liquid chromatography-tandem mass spectrometers such as the API 2000™ mass spectrometer, the API 3000™ mass spectrometer, the API 4000™ mass spectrometer, or the API 5000™ mass spectrometer, such as those described in U.S. Pat. Nos. 4,121,099; 4,137,750; 4,328,420; 4,963,736; 5,179,278; 5,248,875; 5,412,208; and 5,847,386 (Applied Biosystems/MDS SCIEX, Foster City, Calif./Concord Ontario, Canada).

After the sample has been ionized, the positively charged or negatively charged ions thereby created may be analyzed to determine a mass-to-charge ratio (i.e., m/z). Suitable analyzers for determining mass-to-charge ratios include quadrupole analyzers, ion traps analyzers, and time-of-flight analyzers. The ions may be detected using several detection modes. For example, selected ions may be detected (i.e., using a selective ion monitoring mode (SIM)), or alternatively, ions may be detected using a scanning mode, e.g., multiple reaction monitoring (MRM) or selected reaction monitoring (SRM). Preferably, the mass-to-charge ratio is determined using a quadrupole analyzer. For example, in a “quadrupole” or “quadrupole ion trap” instrument, ions in an oscillating radio frequency field experience a force proportional to the DC potential applied between electrodes, the amplitude of the RF signal, and m/z. The voltage and amplitude can be selected so that only ions having a particular m/z travel the length of the quadrupole, while all other ions are deflected. Thus, quadrupole instruments can act as both a “mass filter” and as a “mass detector” for the ions injected into the instrument.

One may enhance the resolution of the MS technique by employing “tandem mass spectrometry,” or “MS/MS.” In this technique, a precursor ion (also called a parent ion) generated from a molecule of interest can be filtered in an MS instrument, and the precursor ion is subsequently fragmented to yield one or more fragment ions (also called daughter ions or product ions) that are then analyzed in a second MS procedure. By careful selection of precursor ions, only ions produced by certain analytes are passed to the fragmentation chamber, where collision with atoms of an inert gas to produce the daughter ions. Because both the precursor and fragment ions are produced in a reproducible fashion under a given set of ionization/fragmentation conditions, the MS/MS technique can provide an extremely powerful analytical tool. For example, the combination of filtration fragmentation can be used to eliminate interfering substances, and can be particularly useful in complex samples, such as biological samples.

Additionally, recent advances in technology, such as matrix-assisted laser desorption/ionization coupled with time-of-flight analyzers (“MALDI-TOF”) permit the analysis of analytes at femtomole levels in very short ion pulses. Mass spectrometers that combine time-of-flight analyzers with tandem MS are also well known to the artisan. Additionally, multiple mass spectrometry steps can be combined in methods known as “MS/MSₙ. ” Various other combinations may be employed, such as MS/MS/TOF, MALDI/MS/MS/TOF, or SELDI/MS/MS/TOF mass spectrometry.

The mass spectrometer typically provides the user with an ion scan; that is, the relative abundance of each ion with a particular m/z over a given range (e.g., 100 to 2000 amu). The results of an analyte assay, that is, a mass spectrum, can be related to the amount of the analyte in the original sample by numerous methods known in the art. For example, given that sampling and analysis parameters are carefully controlled, the relative abundance of a given ion can be compared to a table that converts that relative abundance to an absolute amount of the original molecule. Alternatively, molecular standards can be run with the samples, and a standard curve constructed based on ions generated from those standards. Using such a standard curve, the relative abundance of a given ion can be converted into an absolute amount of the original molecule. In certain embodiments, an internal standard is used to generate a standard curve for calculating the quantity of the radioactive thyroxine. Methods of generating and using such standard curves are well known in the art and one of ordinary skill is capable of selecting an appropriate internal standard. For example, an isotope of a thyroxine may be used as an internal standard, such as a deuterium-labeled thyroxine. Numerous other methods for relating the presence or amount of an ion to the presence or amount of the original molecule will be well known to those of ordinary skill in the art.

One or more steps of the methods of the invention can be performed using automated machines. In certain embodiments, one or more purification steps are performed on-line, and more preferably all of the purification and mass spectrometry steps may be performed in an on-line fashion.

In certain embodiments, such as MS/MS, where precursor ions are isolated for further fragmentation, collision activation dissociation is often used to generate the fragment ions for further detection. In CAD, precursor ions gain energy through collisions with an inert gas, and subsequently fragment by a process referred to as “unimolecular decomposition”. Sufficient energy must be deposited in the precursor ion so that certain bonds within the ion can be broken due to increased vibrational energy.

In certain embodiments radioactive thyroxine is detected and/or quantified using LC-MS/MS as follows. The samples are subjected to liquid chromatography, preferably HPLC, the flow of liquid solvent from the chromatographic column enters the heated nebulizer interface of a LC-MS/MS analyzer and the solvent/analyte mixture is converted to vapor in the heated tubing of the interface. The analytes (i.e., radioactive thyroxine), contained in the nebulized solvent, are ionized by the corona discharge needle of the interface, which applies a large voltage to the nebulized solvent/analyte mixture. The ions, i.e., precursor ions, pass through the orifice of the instrument and enter the first quadrupole. Quadrupoles 1 and 3 (Q1 and Q3) are mass filters, allowing selection of ions (i.e., “precursor” and “fragment” ions) based on their mass-to-charge ratio (m/z). Quadrupole 2 (Q2) is the collision cell, where ions are fragmented. The first quadrupole of the mass spectrometer (Q1) selects for molecules with the mass-to-charge ratios of the radioactive thyroxine to be analyzed. Precursor ions with the correct m/z ratios of the precursor ions of radioactive thyroxine are allowed to pass into the collision chamber (Q2), while unwanted ions with any other m/z collide with the sides of the quadrupole and are eliminated. Precursor ions entering Q2 collide with neutral Argon gas molecules and fragment. This process is called Collision Activated Dissociation (CAD). The fragment ions generated are passed into quadrupole 3 (Q3), where the fragment ions of radioactive thyroxine are selected while other ions are eliminated.

The methods of the invention may involve MS/MS performed in either positive or negative ion mode. Using standard methods well known in the art, one of ordinary skill is capable of identifying one or more fragment ions of radioactive thyroxine that can be used for selection in quadrupole 3 (Q3).

As ions collide with the detector they produce a pulse of electrons that are converted to a digital signal. The acquired data is relayed to a computer, which plots counts of the ions collected versus time. The resulting mass chromatograms are similar to chromatograms generated in traditional HPLC methods. The areas under the peaks corresponding to particular ions, or the amplitude of such peaks, are measured and the area or amplitude is correlated to the amount of the analyte (radioactive thyroxine) of interest. In certain embodiments, the area under the curves, or amplitude of the peaks, for fragment ion(s) and/or precursor ions are measured to determine the amount of radioactive thyroxine. As described above, the relative abundance of a given ion can be converted into an absolute amount of the original analyte, i.e., radioactive thyroxine, using calibration standard curves based on peaks of one or more ions of an internal molecular standard.

In certain aspects of the invention, the quantity of various ions is determined by measuring the area under the curve or the amplitude of the peak and a ratio of the quantities of the ions is calculated and monitored (i.e., “daughter ion ratio monitoring”). In certain embodiments of the method, the ratio(s) of the quantity of a precursor ion and the quantity of one or more fragment ions of radioactive thyroxine can be calculated and compared to the ratio(s) of a molecular standard of the deuterated thyroxine similarly measured. In embodiments where more than one fragment ion of a radioactive thyroxine metabolite is monitored, the ratio(s) for different fragment ions may be determined instead of, or in addition to, the ratio of the fragment ion(s) compared to the precursor ion. In embodiments where such ratios are monitored, if there is a substantial difference in an ion ratio in the sample as compared to the molecular standard, it is likely that a molecule in the sample is interfering with the results. To the contrary, if the ion ratios in the sample and the molecular standard are similar, then there is increased confidence that there is no interference. Accordingly, monitoring such ratios in the samples and comparing the ratios to those of authentic molecular standards may be used to increase the accuracy of the method.

In certain embodiments of the invention, the presence or absence or amount of two or more analytes in a sample might be detected in a single assay using the above described MS/MS methods.

### Isotope Dilution Tandem Mass Spectrometry

Quantification using spiking with isotopically labeled compounds (the isotope dilution method) has helped to generate many valuable contributions to science. The approach relies on linearity of signal versus molecular concentration and reproducibility of sample processing. Specifically, isotope dilution tandem mass spectrometry incorporates additional dilution steps that act as an internal calibration so that an independent isotopic reference material is not required. It avoids the need to measure the isotope ratio of the highly enriched spike directly, and enables the final results to be arranged as a combination of measurements that are largely insensitive to instrumental bias and drift. Consequently, it has the potential to extend the scope of application of isotope dilution tandem mass spectrometry to include analysis for which reference materials with certified isotope ratios are not available or where contamination of the instrument by the highly enriched spike causes difficulty.

The use of isotope dilution tandem mass spectrometry for the analysis of thyroid hormones can be found in U.S. Pat. No. 7,618,827, which is hereby incorporated by reference. Further methods for simultaneously measuring iodothyronines using LC/MS/MS within a single run have been published. See, for example, Gu, J., O. P. Soldin, and S. J. Soldin, Simultaneous quantification of free triiodothyronine and free thyroxine by isotope dilution tandem mass spectrometry. Clin Biochem, 2007. 40(18): p. 1386-91; Soldin, S. J., et al., The measurement of free thyroxine by isotope dilution tandem mass spectrometry. Clin Chim Acta, 2005. 358(1-2): p. 113-8; Soukhova, N., O. P. Soldin, and S. J. Soldin, Isotope dilution tandem mass spectrometric method for T4/T3. Clin Chim Acta, 2004. 343(1-2): p. 185-90; Soldin, O. P., D. M. Mendu, and S. J. Soldin, Development of a method for the simultaneous measurement of stable isotope C13-and C12-thyroxine in human serum or plasma. Thyroid, 2008. 18(1): p. S-85; and Soldin, O. P., J. Gu, and S. J. Soldin, Thyronamines: Tandem Mass Spectrometry Quantification in Biological Fluids. Thyroid, 2009. 19(s1): p. S-100-S-116).

Because isotopes of the same element have the same chemical characteristics and therefore behave almost identically, their mass differences, due to a difference in the number of neutrons, result in fractionation and thus are quantifiable using the highly sensitive methods disclosed herein.

### Implications for Biodefense

Radiological and nuclear threats to the nation are complex, encompassing the detonation of conventional explosives combined with radioactive materials (“dirty bombs”), placement of radioactive sources in public locations, contamination of food and water supplies, attacks on nuclear reactors or sites where radioactive materials are stored, or, in a worst-case scenario, the detonation of a nuclear explosive device. The need for urgent intervention following radiation exposure, and the medical complexities of acute and chronic radiation injury would first necessitate a reliable and quantitative biomarker of exposure to optimize treatment and to triage those who would need it most urgently. In the event of a radiation emergency, potassium iodide (KI) protects against radioactive iodine. For example, it is suggested that after exposure that 130 mg KI should be ingested orally/day within 2-4 hours (for two days). ¹³¹I-thyroxine can serve as a biomarker of exposure following KI treated people because ¹³¹I-thyroxine is detectable radioactive iodine (¹³¹I) that has been internalized (e.g. ingested) and incorporated into thyroxine by the thyroid. Therefore, in certain embodiments, the methods disclosed herein may be used to triage a subject who has been exposed to radiations and to further determine the duration of treatment needed.

### Exemplification

The invention now being generally described, it will be more readily understood by reference to the following, which is included merely for purposes of illustration of certain aspects and embodiments of the present invention, and is not intended to limit the invention.

### General LC/MS/MS Method

An API-5000 tandem mass spectrometer (SCIEX, Toronto, Canada) equipped with TurbolonSpray source and Shimadzu HPLC system is employed to perform the analysis using isotope dilution with a deuterium-labeled thyroxine (L-thyroxin-d₆) as an internal standard for each analyte. 200 μL of human plasma/serum is deproteinated by adding 200 μL of acetonitrile containing internal standards. After centrifugation, 250 μL of supernatant is diluted with 250 μL of distilled de-ionized water and a 250 μL aliquot is injected onto an Agilent Zorbox SB-C18 (2.1×30 mm, 1.8-micron) chromatographic column, where it undergoes cleaning with 2% (v/v) methanol in 0.01% formic acid at a flow rate of 0.25 mL/min. After a 5 min wash, the switching valve is activated and the analytes of interest are eluted from the column with a water/methanol gradient at a flow rate of 0.25 mL/min and then introduced into the mass spectrometer. The gradient parameters are listed in FIG. 2. Quantification by multiple reaction-monitoring (MRM) analysis is performed in the positive mode. Nitrogen serves as auxiliary, curtain, and collision gas. The main working parameters of the mass spectrometer are: collision gas 11, curtain gas 20, nebulizer gas 40, turbo gas 45, ionspray voltage -4500 V, entrance potential -10 V, probe temperature 650° C., and dwell time 150 msec. Accuracy and precision are evaluated by analyzing three concentration levels of in-house quality controls.

This LC/MS/MS-ESI method demonstrates excellent specificity, accuracy (93-103% for all analytes in FIG. 2) and precision (CVs of 4.1-6.2% for all analytes in FIG. 2); it is simple and fast (less than 9 min); and enables the detection of multiple analytes at the same time. A specific application of this method to selected analytes is provided below.

### LC/MS/MS Method for Measuring 13-C T4, D2-T4 and 12-C T4

A tandem mass spectrometer and HPLC system was used, employing isotope dilution with deuterium-labeled thyroxine as internal standard (L-thyroxin-d₂; D2-T4). 150 μL of internal standard in methanol was added to 100 μL of plasma/serum for deproteination, vortexed and centrifuged at 10,000 rpm for 10 minutes; 50 μL of the resulting supernatant was injected onto a C-18 column. After sample injection the column was washed with an 80/20 mixture of 5 mmol ammonium acetate/methanol for 3 minutes. The switch valve was activated with column eluate now going through the mass spectrometer. Over the period of 3.0-7.4 minutes the methanol gradient was increased from 74 to 77% methanol and from 7.4-9.0 minutes the column was cleaned with 100% methanol. Quantification by multiple reaction-monitoring (MRM) analysis was performed in the negative mode. The transitions to monitor were selected at mass-to-charge m/z 782→127 for 13-C T4, m/z 778→127 for d2-T4, and 776→127 for 12-C T4. Nitrogen served as auxiliary, curtain, and collision gas. The main working parameters of the mass spectrometer were: collision gas 11, curtain gas 20, nebulizer gas 40, turbo gas 45, ionspray voltage −4500 V, entrance potential -10 V, probe temperature 650° C., and dwell time 150 msec. Accuracy and precision were evaluated by analyzing three concentration levels of in-house quality controls.

This LC/MS/MS-ESI method demonstrated excellent specificity, accuracy and precision (CVs of 4.1-6.2 at 2.6-11.9 μg/dL for C-12 T4 and 9.2% at 2.0 ng/mL for 13-C T4), it is simple and fast (less than about 7 min). In one normal control after administration of 100 μg of 13-C T4, the 13-C T4 and 12-C T4 were 0.00 and 6.9 μg/dL at t=0 h, 0.99 ng/mL and 7.4 μg/dL at t=3.6 h and 0.7 ng/mL and 7.5 μg/dL at t=18 h, respectively.

Statistical Analysis. Continuous variables will be tested for normal distribution by Kolmogorov-Smirnov test. Data non-normally distributed will be compared by Mann-Whitney test. Categorical variables will be presented as proportions and analyzed between groups with the χ² test (or Fisher's test when appropriate). P<0.05 will be considered significant.

### Incorporation by Reference

The contents of the articles, patents, and patent applications, and all other documents and electronically available information mentioned or cited herein, are hereby incorporated by reference in their entirety to the same extent as if each individual publication was specifically and individually indicated to be incorporated by reference. Applicant reserves the right to physically incorporate into this application any and all materials and information from any such articles, patents, patent applications, or other physical and electronic documents.

### Equivalents

The invention has been described broadly and generically herein. Those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention. Further, each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

1. A method comprising the steps of:
(a) preparing an analytical sample from a biological sample comprising radioactive thyroxine;
(b) ionizing at least a portion of the analytical sample using a mass spectrometer, thereby generating at least one radioactive thyroxine derived ion;
(c) quantifying the amount of the at least one radioactive thyroxine derived ion; and
(d) determining the amount of radioactive thyroxine in the biological sample based on the amount of said at least one radioactive thyroxine derived ion;
wherein radioactive thyroxine is represented by 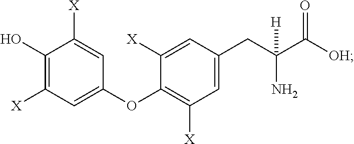
and X is, independently for each occurrence, ¹²⁷I, ¹²⁹I or ¹³¹I, provided that at least one instance of X is ¹³¹I or ¹²⁹I.

2. The method of claim 1, wherein the biological sample is selected from the group consisting of blood, plasma, serum, urine, cerebrospinal fluid, amniotic fluid and saliva.

3. (canceled)

4. The method of claim 1, wherein the biological sample was taken from a subject exposed to radiation.

5. The method of claim 1, wherein the biological sample was taken from a post-operative thyroidectomy patient.

6. (canceled)

7. The method of claim 1, wherein the step of preparing the analytical sample comprises the step of deproteinating the biological sample.

8. (canceled)

9. (canceled)

10. The method of claim 1, wherein the step of preparing the analytical sample comprises the step of separating the radioactive thyroxine from the analytical sample.

11. The method of claim 10, wherein the step of separating the radioactive thyroxine from the analytical sample comprises the use of a C-18 chromatography column.

12. (canceled)

13. (canceled)

14. The method of claim 1, wherein the method takes an amount of time to complete; and the amount of time to complete the method is less than about one hour.

15. (canceled)

16. The method of claim 1, wherein the mass spectrometer is a quadrupole time-of-flight mass spectrometer, matrix-assisted laser desorption/ionization time-of-flight spectrometer, ion trap time-of-flight mass spectrometer, time-of-flight mass spectrometer or a triple quadrupole mass spectrometer.

17. The method of claim 1, wherein the step of ionizing the analytical sample comprises an ionization technique selected from the group consisting of photoionization, electrospray ionization, atmospheric pressure chemical ionization, and electron capture ionization.

18-20. (canceled)

21. The method of claim 1, wherein the quantification of the at least one radioactive thyroxine derived ion comprises multiple reaction-monitoring analysis.

22. The method of claim 1, wherein the quantification of the at least one radioactive thyroxine derived ion comprises selected ion monitoring.

23. The method of claim 1, wherein the biological sample further comprises non-radioactive thyroxine; the step of ionizing the analytical sample using a mass spectrometer further generates at least one non-radioactive thyroxine derived ion; and the method further comprises the step of quantifying the at least one non-radioactive thyroxine derived ion in the biological sample, thereby determining the amount of non-radioactive thyroxine in the biological sample.

24. (canceled)

25. The method of claim 1, wherein the biological sample further comprises one or more additional radioactive iodothyronine(s); and the step of ionizing the analytical sample using a mass spectrometer further generates one or more radioactive iodothyronine derived ion(s).

26. The method of claim 25, wherein the step of quantifying the at least one radioactive thyroxine derived ion also quantifies the one or more additional radioactive iodothyronine(s) ions in the analytical sample; and the method further comprises determining the amount of radioactive iodothyronine(s) in the biological sample based on the amount of the one or more radioactive iodothyronine(s) derived ion(s).

27. The method of claim 25, wherein the method further comprises the step of quantifying the one or more radioactive iodothyronine derived ion(s) in the analytical sample; and the method further comprises determining the amount of radioactive iodothyronine(s) in the biological sample based on the amount of the one or more radioactive iodothyronine(s) derived ion(s).

28. The method of claim 25, wherein the one or more additional radioactive iodothyronine(s) comprise radioactive triiodothyronine;
the radioactive triiodothyronine is represented by 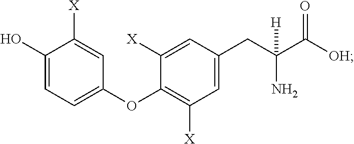
and each X is, independently for each occurrence, ¹²⁷I, ¹²⁹I or ¹³¹I, provided that at least one instance X is ¹³¹I or ¹²⁹I.

29. The method of claim 1, wherein the step of preparing the analytical sample comprises adding an internal standard to the biological sample.

30. The method of claim 29, wherein the internal standard is deuterated thyroxine.

31-38. (canceled)

39. A kit for use in mass spectrometric analysis of a biological sample comprising radioactive thyroxine, comprising: reagents for preparing an analytical sample from the biological sample; and instructions for analyzing the analytical sample.

40-43. (canceled)
